(19) United States
(12) Patent Application Publication
(10) Pub. No.: US 2024/0218602 A1
(43) Pub. Date: Jul. 4, 2024

(54) BARRIER LAYER FOR CELLULOSE SUBSTRATE

(71) Applicant: COATEX, Genay (FR)

(72) Inventors: Francis BONY, Quincieux (FR); François DUPONT, Lyon (FR); Jacques MONGOIN, Quincieux (FR)

(73) Assignee: COATEX, Genay (FR)

(21) Appl. No.: 18/555,669

(22) PCT Filed: Apr. 12, 2022
(86) PCT No.: PCT/FR2022/000030

§ 371 Date: Oct. 16, 2023

(30) Foreign Application Priority Data
Apr. 29, 2021 (FR) FR2104526

(51) Int. Cl. D21H 21/16; C09D 5/02; C09D 5/16; C09D 7/40; C09D 7/43; C09D 7/45; C09D 7/61; C09D 7/65; C09D 109/08; D21H 19/38; D21H 19/58; D21H 19/62; D21H 23/22; D21H 27/10

(52) U.S. Cl. CPC D21H 21/16; C09D 5/022; C09D 5/027; C09D 5/028; C09D 5/1668; C09D 5/1687; C09D 7/43; C09D 7/45; C09D 7/61; C09D 7/65; C09D 7/68; C09D 7/69; C09D 7/70; C09D 109/08; D21H 19/385; D21H 19/58; D21H 19/62; D21H 23/22; D21H 27/10

(57) ABSTRACT

A barrier layer applied to a cellulose substrate to protect sensitive substances. The cellulose substrate is coated with the barrier layer composition. An aqueous mineral suspension and an aqueous composition for preparing the barrier layer composition includes a polymeric stabilising agent prepared from (meth)acrylic acid and a polyalkoxylated methacrylic derivative.

The invention relates to the field of protecting sensitive substances by means of a barrier layer applied to a cellulose substrate. The cellulose substrate is generally paper or cardboard. It is coated with a barrier layer composition. The invention provides an aqueous mineral suspension and an aqueous composition for preparing a barrier layer which comprise a polymeric stabilising agent and are prepared from (meth)acrylic acid and a polyalkoxylated methacrylic derivative.

The cellulose substrate is generally made of paper or cardboard and is used to package goods. The application of a barrier layer provides protection by reducing the migration of aqueous, organic or aromatic liquids as well as the migration of gases (for example, oxygen, water vapour, flavours). Migration can take place from the external environment to packaged goods, or from packaged goods to the external environment. The packaged goods are very often foodstuffs.

Many sensitive substances require protection, especially when they are transported or stored. In addition, many substances have to be retained so that they do not penetrate or permeate the substrate that surrounds or envelops them. There is therefore a major need for methods of preparing barrier layers, particularly for coating cellulose substrates. Such barrier layers must be able to prevent or slow the penetration of at least one substance through the cellulose substrate. The barrier layer must be able to block at least one gaseous, liquid or solid substance. In particular, this barrier layer must be able to block water, alcohols, natural oils, mineral oils, gases such as water vapour, O₂, CO₂, fats, organic solvents, flavours or fragrances.

Such barrier properties are particularly desirable for preparing barrier layers for a cellulose substrate, in particular for a natural or plant-based cellulose substrate or for a composite or mixed cellulose substrate. The cellulose substrates for which such barrier layers are particularly useful are new paper made from new cellulose fibres, new cardboard made from new cellulose fibres, recycled paper or recycled cardboard, mainly made from recovered paper or cardboard.

In particular, it is important to have cellulose substrates coated with an effective barrier layer, particularly for a cellulose substrate in the form of a container, of a package, in particular of a food container or of a food package, of a non-food container or of a non-food package, of a drug container or of a drug package, of a container or of a package for an oxidisable substance, of a container or of a package for a hygroscopic substance. The barrier layer can protect the substance contained in the package or in the container. The barrier layer can also be used to prevent the substance, or some of its liquid or gaseous, aqueous or organic components, wrapped or contained in the packaging or in the container, from leaking from or migrating through the packaging, thus preventing this substance from coming into contact with the environment outside the coated cellulose substrate.

For such uses, plastic polymer-based barrier layers are generally available, but their use should be avoided or limited, particularly for environmental reasons. However, it is now preferable to use barrier layers made from mineral pigments combined with a binding agent. Nevertheless, barrier layer compositions combining a mineral pigment and a binding agent regularly lead to the appearance of flaws in the barrier layer deposited on the cellulose substrate. The most common flaws appear as scratches or as uneven, incomplete or discontinuous areas of the barrier layer.

These flaws must absolutely be minimised or eliminated because they reduce or even obliterate the efficacy of the barrier layer. Indeed, these flaws are likely to insufficiently prevent or slow the penetration of the substances to be controlled through the barrier layer or their diffusion within the barrier layer. Flaws in barrier layers are caused by the formation or growth of particle clusters in the composition used to prepare the barrier layer or in the mineral suspension used to prepare this composition. Indeed, as soon as such particle clusters form or are of a size comparable to the thickness of the barrier layer, they can cause numerous flaws when the barrier layer is applied to the surface of the cellulose substrate.

The presence of such flaws, even in very small numbers, can lead to the total or partial loss of efficacy of the barrier layer. The cellulose substrate can then be penetrated or permeated by substances that the barrier layer should keep out.

Document EP 2777934 describes barrier layer preparation compositions for multi-layer packaging comprising a water vapour barrier layer overlaid with a gas barrier layer. These compositions can comprise a sodium polyacrylate. Moreover, documents FR 2846978, FR 2917091 and US 20110305915 describe the preparation of paper coating colours comprising a pigment, a latex binder and various polymeric additives.

The known barrier layer preparation compositions and the known mineral suspensions for preparing these compositions do not make it possible to provide an effective and satisfactory solution to these problems.

The invention provides a barrier layer preparation composition and a mineral suspension for preparing this composition that make it possible to provide a solution to all or part of the problems of the barrier layer preparation compositions and of the mineral suspensions for preparing these compositions in the prior art.

Thus, the invention provides an aqueous mineral suspension S for the preparation of an aqueous barrier layer composition C for a cellulose substrate, comprising water and, relative to the total amount of dry active ingredients in the suspension,
a. 5 to 34.9% by dry weight of at least one mineral pigment (a) chosen among the alkaline-earth metal carbonates, magnesium carbonate, barium carbonate, dolomite, kaolin, titanium dioxide, talc, lime, calcium sulphate, barium sulphate, hexacalcium hexaoxotris-sulphato(2-)-dialuminate(12-) (white satin), silica and combinations thereof;
b. 65 to 93% by dry weight of at least one binding agent (b) chosen among a binding agent (b1) in the form of a latex prepared by emulsion polymerisation and a polymer binding agent (b2) in the form of an aqueous dispersion and combinations thereof;
c. 0.1 to 2% by dry weight of at least one stabilising agent (c) prepared by at least one polymerisation reaction
   of at least one monomer (c1) chosen among acrylic acid, an acrylic acid salt, methacrylic acid, a methacrylic acid salt and combinations thereof;
   of at least one compound (c2) of formula (I):

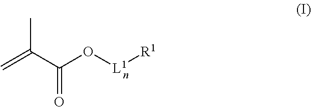

wherein:
R¹ independently represents H or a CH₃ group;
L¹ independently represents ethylene oxide (EO) groups or a combination of EO groups and of propylene oxide (PO) groups;
n independently represents an integer or decimal comprised between 20 and 200.

The aqueous suspension S according to the invention comprises four essential components. In addition to water, the suspension S comprises three types of active ingredients: the pigment (a), agent (b1) or agent (b2) and the stabilising agent (c). According to the invention and unless otherwise indicated, the amounts of active ingredients are expressed in amounts of dry ingredient.

According to the invention, the suspension S is an aqueous suspension. The active ingredients are therefore mixed with water. Generally, this aqueous suspension S comprises an amount by weight of water of about 50% relative to the total weight of the aqueous suspension S. However, depending on the conditions in which this aqueous suspension S is prepared or is used, the amount of water may vary. For example, the aqueous suspension S can comprise 30% by weight or 40% by weight of water but also up to 60% by weight or up to 70% by weight of water. Most of the water in the suspension S comes from water used as a carrier medium. A fraction of the water in the aqueous suspension S comes from water used for carrying or for producing one or another of the active ingredients, in particular water from the latex in agent (b1), water from the dispersion of binding agent (b2) or water that may be used as a carrier for the pigment (a) or water that may be used as a carrier for the stabilising agent (c).

According to the invention, the stabilising agent (c) makes it possible to control or reduce the size of the particle clusters that may be present or that may form in the suspension S or in a barrier layer composition for a cellulose substrate prepared using this suspension S.

Generally, the agent (c) makes it possible to eliminate or reduce the size of the mineral pigment particle clusters (a) or of the binding agent particle clusters (b). According to the invention, the agent (c) therefore makes it possible to control or improve the homogeneity of a barrier layer on a cellulose substrate.

Preferably according to the invention, the suspension S comprises a pigment (a) chosen among natural calcium carbonate, precipitated calcium carbonate, kaolin, calcined kaolin, talc, titanium dioxide and combinations thereof. The preferred pigment (a) according to the invention is calcium carbonate, optionally combined with kaolin or with talc.

Also preferably according to the invention, the suspension S comprises a pigment (a) in the form of particles, preferably particles with a size of less than 10 μm or with a size ranging from 0.05 μm to 10 μm or with a size of less than 8 μm, preferably less than 5 μm or less than 2 μm, more preferentially less than 1 μm or less than 0.5 μm. Also preferably according to the invention, the suspension S comprises a pigment (a) in the form of particles of which the equivalent spherical diameter, for a size ranging from 0.05 μm to 10 μm or less than 10 μm, preferably for a size of less than 8 μm, more preferentially less than 5 μm or less than 2 μm or less than 0.3 μm, even more preferentially less than 1 μm or less than 0.5 μm or less than 0.3 μm, is equal to 60% by weight or equal to 70% by weight or even equal to 80% by weight or even equal to 90% by weight. According to the invention, the particle size is measured by laser diffraction.

According to the invention, the pigment (a) can be surface treated or can comprise no surface treatment. For example, the pigment (a) can be hydrophobically surface treated. Fatty acids, such as stearic acid, ricinoleic acid, palmitic acid, can be used to treat the surface of the pigment (a). Other substances can be used to treat the surface of the pigment (a), for example, a surfactant compound, a modified hydrophobic polymer, a styrene-acrylic resin emulsion, a styrene-butadiene latex emulsion, a styrene-acrylic and styrene latex mixture, a silane, a siloxane, a siloxane-silicone resin combination.

The binding agent (b) is an essential active ingredient of the suspension S according to the invention. Preferably, the suspension S according to the invention comprises a binding agent (b1) which is in the form of a latex binder prepared by emulsion polymerisation of at least one ethylenically unsaturated monomer. More preferably, the binding agent (b1) is prepared from a monomer chosen among styrene, ethylene, butadiene, vinyl acetate, carboxylic acids comprising an ethylenic unsaturation (more preferentially acrylic acid and methacrylic acid), acrylic acid ester, methacrylic acid ester, acrylamide, methacrylamide, acrylonitrile, methacrylonitrile, acrylonitrile ester, methacrylonitrile ester and combinations thereof.

Also preferably, the suspension S according to the invention comprises a binding agent (b1) which is in the form of a latex binder prepared by emulsion polymerisation
of at least one monomer chosen among styrene, ethylene, butadiene, vinyl acetate, carboxylic acids comprising an ethylenic unsaturation (more preferentially acrylic acid and methacrylic acid), acrylic acid ester, methacrylic acid ester, acrylamide, methacrylamide, acrylonitrile, methacrylonitrile, acrylonitrile ester, methacrylonitrile ester, combinations thereof and
of at least one additional monomer chosen among fumaric acid, itaconic acid, maleic acid, fumaric acid ester, itaconic acid ester, maleic acid ester, silanes, siloxanes, and combinations thereof.

More preferably, the suspension S according to the invention comprises a binding agent (b1) chosen among acrylic latex, carboxylated styrene-butadiene latex, non-carboxylated styrene-butadiene latex, styrene-acrylate latex, styrene-butyl acrylate latex, butadiene-methyl methacrylate latex, butadiene-acrylonitrile latex, polyvinyl acetate latex and combinations thereof.

Also preferably, the suspension S according to the invention comprises a binding agent (b2) which is chosen among aqueous dispersions of bonding polymers chosen among polyethylenes (PE), polypropylenes (PP), ethylene-vinyl acetate (EVA) polymers, ethylene-acrylic acid (EAA) polymers, ethylene-methacrylic acrylic acid (EMAA) polymers, ethylene-butyl acrylate (EBA) polymers, ethylene-methyl acrylate (EMA) polymers, styrene-isoprene block (SIS) copolymers, styrene-butadiene block (SBS) copolymers, styrene-ethylene-butylene block (SEBS) polymers, acrylic acid-modified ethylene copolymers, polyvinyl alcohols, modified polyvinyl alcohols, preferably EAA, EVA, SBS.

Essentially according to the invention, the suspension S comprises at least one binding agent (b). It can be used alone or combined with at least one other binding agent (b′). Preferably according to the invention, the binding agent (b′) is natural. It is preferably a binding agent (b′) chosen among carboxymethyl celluloses, starches, modified starches, proteins, caseins, alginates and combinations thereof.

The stabilising agent (c) is an essential active ingredient of the suspension S according to the invention. Preferably, the suspension S according to the invention comprises an agent (c) that is a polymer prepared by a polymerisation reaction of at least one monomer (c1) chosen among acrylic acid, methacrylic acid and combinations thereof. Also preferably, the suspension S according to the invention comprises an agent (c) that is a polymer prepared by a polymerisation reaction of at least one monomer (c2) of formula I wherein L¹ represents EO.

According to the invention, the stabilising agent (c) can be used in its acid form. Also preferably according to the invention, the agent (c) is fully or partially neutralised. The agent (c) can be neutralised by means of a compound chosen among NaOH, KOH, LiOH, Mg(OH)₂, Ca(OH)₂, ZnO, CaO, MgO, ammonium derivatives, ammonia, amino bases, for example triethanolamine, aminomethylpropanol or 2-amino-2-methyl-propanol (AMP) and combinations thereof, in particular NaOH or KOH combined with Ca(OH)₂ or Mg(OH)₂. NaOH and KOH are preferred.

Also preferably according to the invention, the agent (c) has a weight-average molecular weight M_{W} measured by size exclusion chromatography (SEC) of less than 40,000,000 g/mol, preferably less than 20,000,000 g/mol or less than 15,000,000 g/mol, more preferentially less than 10,000,000 g/mol or less than 5,000,000 g/mol. Also preferably according to the invention, the agent (c) has a weight-average molecular weight M_{W} measured by size exclusion chromatography (SEC) greater than 100,000 g/mol or greater than 300,000 g/mol or greater than 500,000 g/mol or even greater than 1,000,000 g/mol. Very preferably according to the invention, the agent (c) has a weight-average molecular weight M_{W} measured by size exclusion chromatography (SEC) ranging from 1,000,000 g/mol to 5,000,000 g/mol. Also preferably according to the invention, the agent (c) has a polymolecularity index (PI) measured by size exclusion chromatography (SEC) of less than 2.8 or a polymolecularity index (PI) ranging from 1.5 to 3, from 1.5 to 2.8 or ranging from 1.5 to 2.5.

In addition to compounds (c1) and (c2), the agent (c) can be prepared by a polymerisation reaction using other compounds. Thus, according to the invention, the agent (c) can be prepared by a polymerisation reaction using at least one additional monomer (c3), different from monomers (c1) and (c2), chosen among maleic acid, maleic anhydride, itaconic acid, 2-acrylamido-2-methylpropane sulphonic acid (AMPS), vinylsulphonic acid, 2-(methacryloyloxy)-ethanesulphonic acid, sodium methallyl sulphonate, styrene sulphonate and salts thereof, preferably itaconic acid, 2-acrylamido-2-methylpropane sulphonic acid (AMPS) and salts thereof According to the invention, the agent (c) can be prepared by a polymerisation reaction using at least one additional monomer, different from monomers (c1) and (c2), which is a compound (c4) of formula (II):

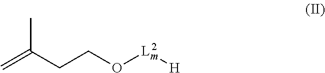

wherein:
L² independently represents an EO group or a combination of EO and PO groups;
m independently represents an integer or decimal comprised between 10 and 150; preferably between 20 and 75;
EO independently represents an ethylene oxide group;
PO independently represents a propylene oxide group.

According to the invention, the agent (c) can be prepared by a polymerisation reaction using at least one additional monomer, different from monomers (c1) and (c2), which is a monomer (c5) of formula (III):

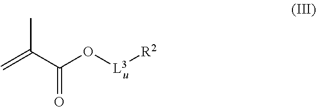

wherein:
L³ independently represents an EO group or a combination of EO and PO groups;
u independently represents an integer or decimal comprised between 10 and 150; preferably between 20 and 75;
EO independently represents an ethylene oxide group;
PO independently represents a propylene oxide group;
R² independently represents H or CH₃.

According to the invention, the agent (c) can be prepared by a polymerisation reaction using at least one additional monomer, different from monomers (c1) and (c2), which is a monomer (c6) of formula (IV):

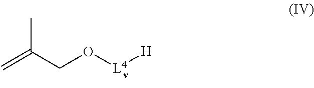

wherein:
L⁴ independently represents an EO group;
EO independently represents an ethylene oxide group;
v independently represents an integer or decimal comprised between 10 and 150; preferably between 20 and 75.

According to the invention, the agent (c) can be prepared by a polymerisation reaction using at least one additional monomer, different from monomers (c1) and (c2), which is a monomer (c6a) of formula (V):

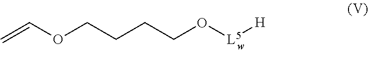

wherein:
L⁵ independently represents an EO group;
EO independently represents an ethylene oxide group;
w independently represents an integer or decimal comprised between 10 and 150; preferably between 20 and 75.

According to the invention, the agent (c) can be prepared by a polymerisation reaction using at least one additional monomer, different from monomers (c1) and (c2), which is a compound (c7) of formula (VI):

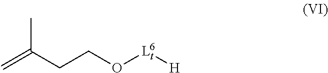

wherein:
L⁶ independently represents an EO group or a combination of EO and PO groups;
t independently represents an integer or decimal comprised between 10 and 150; preferably between 20 and 75;
EO independently represents an ethylene oxide group;
PO independently represents a propylene oxide group.

Particularly advantageously, the stabilising agent (c) according to the invention makes it possible to act on the stability of the suspension S according to the invention. In particular, the agent (c) can act on the formation of particle clusters or on the growth of particle clusters that may form in the suspension S. The particle clusters that may form in the suspension S according to the invention may be particle clusters of pigment (a), particle clusters of binding agent (b) or particle clusters of a composite of binding agent (b) and of pigment (a). Preferably according to the invention, the suspension S has less than 10% by volume of clusters larger than 20 μm, measured by laser diffraction. Also preferably according to the invention, the suspension S has less than 30% by volume of clusters larger than 10 μm, measured by laser diffraction. Particularly preferably according to the invention, the suspension S does not comprise any clusters larger than 100 μm, nor does it comprise any clusters larger than 80 μm or larger than 70 μm.

Preferably, the suspension S according to the invention has a pH greater than 5, preferably greater than 5.5, more preferentially greater than 6 or than 6.5. Also preferably, the suspension S has a pH of less than 13 or less than 12. More preferably, the suspension S has a pH ranging from 5 to 13 or from 5 to 12 or from 5 to 11, preferably ranging from 5.5 to 13 or from 5.5 to 12 or from 5.5 to 11, more preferentially ranging from 6 to 13 or from 6 to 12 or from 6 to 11, also more preferentially ranging from 7 to 13 or from 7 to 12 or from 7 to 11, particularly from 7.5 to 10.

Within the suspension S according to the invention, the amounts of ingredients can vary quite widely. Preferably, the suspension S comprises, relative to the total amount of dry active ingredients of the suspension,
a. 10 to 34.9% by dry weight or 15 to 34.9% by dry weight of mineral pigment (a);
b. 65 to 88% by dry weight or 65 to 83% by dry weight of binding agent (b) and
c. 0.1 to 2% by dry weight of agent (c).

Also preferably, the suspension S comprises, relative to the total amount of dry active ingredients of the suspension,
a. 10 to 29.9% by dry weight or 15 to 29.9% by dry weight of mineral pigment (a);
b. 70 to 88% by dry weight or 70 to 83% by dry weight of binding agent (b) and
c. 0.1 to 2% by dry weight of agent (c).

Also preferably, the suspension S comprises, relative to the total amount of dry active ingredients of the suspension,
a. 10 to 24.9% by dry weight or 15 to 24.9% by dry weight of mineral pigment (a);
b. 75 to 88% by dry weight or 75 to 83% by dry weight of binding agent (b) and
c. 0.1 to 2% by dry weight of agent (c).

Particularly advantageously, the suspension S according to the invention can be used to prepare an aqueous composition that is useful for preparing a barrier layer for a cellulose substrate. Thus, the invention provides an aqueous composition C for preparing a barrier layer for a cellulose substrate, comprising, relative to the total amount of composition,
from 95 to 99.95% by weight or from 95 to 99.9% by weight of at least one suspension S according to the invention,
from 0.05 to 5% by weight or from 0.1 to 5% by weight of at least one thickening agent (e) chosen among the ASE polymers, the HASE polymers and combinations thereof.

The ASE and HASE polymers used according to the invention are known as such. ASE (Alkali-Soluble Emulsion or Alkali-Swellable Emulsion) polymers are copolymers that are soluble or swellable in an alkaline medium. HASE (Hydrophobically modified Alkali-Soluble Emulsion or Hydrophobically modified Alkali-Swellable Emulsion) polymers are hydrophobically modified copolymers that are soluble or swellable in an alkaline medium.

Preferably according to the invention, the aqueous composition C comprises a thickening agent (e) that is an ASE polymer prepared by at least one polymerisation reaction
of at least one monomer (e1) chosen among acrylic acid, an acrylic acid salt, methacrylic acid, a methacrylic acid salt and combinations thereof,
of at least one monomer (e2) chosen among the C₁-C₈ esters of a compound derived from an acid chosen among acrylic acid, methacrylic acid and combinations thereof.

Also preferably according to the invention, the aqueous composition C comprises a thickening agent (e) that is an HASE polymer prepared by at least one polymerisation reaction
of at least one monomer (e1),
of at least one monomer (e2) and
of at least one hydrophobic monomer (e3) of formula VII:

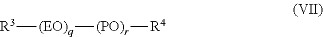

wherein:
q and r, identical or different, independently represent 0 or an integer or decimal less than 150, q or r being different from 0,
EO independently represents an ethylene oxide group (CH₂CH₂O)
PO independently represents a propylene oxide group (CH(CH₃)CH₂O or CH₂CH(CH₃)O),
R³ represents a group comprising at least one polymerisable olefinic unsaturation, preferably chosen among acrylate, methacrylate, acrylurethane, methacrylurethane, vinyl, allyl, methallyl, isopenyl, α-α′-dimethyl-isopropenyl-benzylurethane, allylurethane, maleic acid ester, itaconic acid ester, crotonic acid ester, more preferentially methacrylate,
R⁴ represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group, or a group comprising 2 to 5 phenyl groups or a tristyrylphenyl group or a pentastyrylcumylphenyl group.

Particularly preferably according to the invention, the ASE polymer is prepared by at least one polymerisation reaction using:
from 20 to 75 mol % or from 25 to 70 mol % preferably from 30 to 70 mol % or from 35 to 65 mol %, of monomer (e1) and
from 25 to 80 mol % or from 30 to 75 mol % preferably from 30 to 70 mol % or from 35 to 65 mol %, of monomer (e2),
   relative to the total molar amount of monomers (e1) and (e2).

Also particularly preferably according to the invention, the HASE polymer is prepared by at least one polymerisation reaction using:
from 20 to 75 mol % or from 25 to 70 mol % preferably from 30 to 70 mol % or from 35 to 65 mol %, of monomer (e1) and
from 25 to 80 mol % or from 30 to 75 mol % preferably from 30 to 70 mol % or from 35 to 65 mol %, of monomer (e2),
less than 20 mol %, preferably from 0.05 to 20 mol %, in particular from 0.1 to 10 mol %, of monomer (e3),
   relative to the total molar amount of monomers.

Advantageously according to the invention, in addition to monomers (e1), (e2), optionally monomer (e3), the ASE polymer or the HASE polymer can be prepared by at least one polymerisation reaction that also uses at least one additional different monomer (e4). Preferably according to the invention, monomer (e4) is chosen among 2-acrylamido-2-methylpropane sulphonic acid, ethoxymethacrylate sulphonic acid, sodium methallyl sulphonate, styrene sulphonate, hydroxyethyl acrylate phosphate, hydroxypropyl acrylate phosphate, hydroxyethyl methacrylate phosphate, hydroxypropyl methacrylate phosphate, their salts and combinations thereof, preferably less than 20 mol %, preferably from 0.2 to 20 mol %, in particular from 0.5 to 10 mol %, of monomer (e4) relative to the total molar amount of monomers.

The ASE polymer or the HASE polymer can also be prepared by at least one polymerisation reaction that also uses at least one different additional monomer (e5) chosen among hydroxyethyl-acrylate, hydroxypropyl-acrylate, hydroxyethylhexyl-acrylate, hydroxyethyl methacrylate, hydroxypropyl methacrylate; preferably less than 20 mol %, preferably from 0.2 to 20 mol %, in particular from 0.5 to 10 mol %, of monomer (e5) relative to the total molar amount of monomers.

The ASE polymer or the HASE polymer can also be prepared by at least one polymerisation reaction that also uses at least one different additional cross-linking monomer (e6) or at least one monomer (e6) comprising at least two olefinic unsaturations; preferably less than 5 mol %, preferably from 0.01 to 4 mol %, in particular from 0.02 to 4 mol % or from 0.02 to 2 mol %, particularly from 0.02 to 1 mol %, of monomer (e6) relative to the total molar amount of monomers.

The thickening agent (e) can be used directly or it can be used in a neutralised form. Preferably, agent (e) can be fully or partially neutralised, preferably by means of at least one compound chosen among NaOH, KOH, LiOH, Mg(OH)₂, Ca(OH)₂, ZnO, CaO, MgO, ammonium derivatives, ammonia, amino bases, for example triethanolamine, aminomethylpropanol or 2-amino-2-methyl-propanol (AMP) and combinations thereof, in particular NaOH or KOH combined with Ca(OH)₂ or Mg(OH)₂. NaOH and KOH are preferred.

The agent (e) according to the invention can also be coacervated. It can be fully or partially coacervated. Preferably, the agent (e) can be coacervated by reducing the pH, for example by reducing the pH to a value of less than 6.5. The pH can be reduced by means of an acid compound, in particular by means of least one organic or inorganic acid compound, in particular an acid compound chosen among phosphoric acid, citric acid, glucono-lactone, lactic acid, salicylic acid, glycolic acid, ascorbic acid, glutamic acid, hydrochloric acid, acetic acid, D-gluconic acid, sulphonic acid, methanesulphonic acid, benzimidazole sulphonic acid, tartaric acid, 4-aminobenzoic acid, benzoic acid, sorbic acid, phenyl benzimidazole sulphonic acid, benzylidene camphor sulphonic acid, terephthalylidene dicamphor sulphonic acid, kojic acid, hyaluronic acid. The agent (e) can also be coacervated by increasing the ionic strength, for example, by adding at least one ionised compound or at least one salt, particularly NaCl, KCl, MgCl₂, CaCl₂), MgSO₄, CaSO₄.

The stabilising agent (c) and the ASE or HASE polymers used according to the invention are known as such. They can be prepared by known methods, in particular by a radical polymerisation reaction, for example a polymerisation reaction in an emulsion, in a dispersion or in a solution. The polymerisation can be carried out in a solvent in the presence of at least one initiator compound. As examples of initiator compounds, at least one compound can be used chosen among the azoic initiator compounds (for example azobisisobutyronitrile), a peroxide compound, preferably hydrogen peroxide, benzoyl peroxide, benzoyl hydroperoxide and mixtures thereof. Alkaline metal persulphates can also be mentioned, particularly sodium persulphate and potassium persulphate, ammonium persulphate, partially water-soluble peroxides, particularly succinic peracid, t-butyl hydroperoxide, cumyl hydroperoxide, persulphates combined with a copper ion, a ferrous ion, a sulphite ion or a bisulphite ion and mixtures thereof. Aside from the various monomers, the method of preparing these polymers generally uses at least one chain transfer agent, preferably chosen among the mercaptan compounds, in particular mercaptan compounds comprising at least four carbon atoms such as butyl mercaptan, n-octyl mercaptan, n-dodecyl mercaptan, tert-dodecyl mercaptan, iso-octyl 3-mercaptopropionate. Preferably, the reaction is a radical polymerisation reaction in emulsion. According to the invention, the radical-initiating or radical-generating compound can therefore be combined with at least one controlled radical polymerisation transfer agent, in particular a RAFT (reversible addition-fragmentation chain transfer) transfer agent.

According to the invention, it may be possible to control the pH of the aqueous composition C. Preferably, the aqueous composition C according to the invention has a pH greater than 5, preferably greater than 5.5, more preferentially greater than 6 or than 6.5. Also preferably, the composition C has a pH of less than 11 or less than 10.5. More preferably, the composition has a pH ranging from 4 to 13 or from 4 to 12 or from 4 to 11, preferably ranging from 5 to 13 or from 5 to 12 or from 5 to 11, more preferentially ranging from 6 to 13 or from 6 to 12 or from 6 to 11, also more preferentially ranging from 6.5 to 13 or from 6.5 to 12 or from 6.5 to 11, particularly from 7.5 to 9.5.

The thickening agent (e) is an essential ingredient of the aqueous composition C according to the invention. It is effective in thickening this composition by modifying its rheology. The result is an increase in the viscosity of the aqueous composition C according to the invention. Preferably, the aqueous composition C according to the invention has a Brookfield viscosity, measured at 25° C. at a speed of 100 rpm, greater than 100 mPa·s. In particular, the composition C has a Brookfield viscosity, measured at 25° C. at a speed of 100 rpm, ranging from 100 to 3,000 mPa·s or from 100 to 2,500 mPa·s or from 200 to 3,000 mPa·s or from 200 to 2,500 mPa·s.

By using the suspension S in the aqueous composition C according to the invention, and in particular by using the stabilising agent (c), the composition C generally has a concentration of clusters larger than 20 μm, measured by laser diffraction, that is less than 10% by volume. Also preferably according to the invention, the composition C has less than 30% by volume of clusters larger than 10 μm, measured by laser diffraction. Particularly preferably according to the invention, the composition C does not comprise any clusters larger than 100 μm, nor does it comprise any clusters larger than 80 μm or larger than 70 μm.

In addition to a suspension S and a composition C, the invention also provides methods for preparing them. Thus, a first preparation method according to the invention makes it possible to prepare a suspension S by mixing active ingredients (a), (b) and (c) in water. Preferably the suspension S is prepared by mixing, in water, relative to the total amount of dry active ingredients of the suspension,
5 to 34.9% by dry weight of at least one mineral pigment (a),
65 to 93% by dry weight of at least one binding agent (b) and
0.1 to 2% by dry weight of at least one stabilising agent (c).

The invention also provides a method of preparing the composition C by mixing the suspension S and the thickening agent (e) and optionally water. Preferably, the method of preparing the aqueous barrier layer composition C for a cellulose substrate comprises:
a. preparing an aqueous mineral suspension S according to the invention by mixing, in water, relative to the total amount of active dry ingredients of the suspension,
   8 to 59.9% by dry weight of at least one mineral pigment (a),
   40 to 90% by dry weight of at least one binding agent (b),
   0.1 to 2% by dry weight of at least one stabilising agent (c),
b. adding from 0.05 to 5% by dry weight of the composition C of at least one thickening agent (e) according to the invention. Also preferably, the method of preparing the aqueous barrier layer composition C for a cellulose substrate comprises:
a. preparing an aqueous mineral suspension S according to the invention by mixing, in water, relative to the total amount of active dry ingredients of the suspension,
   5 to 34.9% by dry weight of at least one mineral pigment (a),
   65 to 93% by dry weight of at least one binding agent (b),
   0.1 to 2% by dry weight of at least one stabilising agent (c),
b. adding from 0.05 to 5% by dry weight of the composition C of at least one thickening agent (e) according to the invention.

The aqueous composition C according to the invention makes it possible to prepare a barrier layer on a cellulose substrate. The invention therefore provides a method of preparing a barrier layer for a cellulose substrate comprising the application of at least one aqueous composition C according to the invention to at least one surface of a cellulose substrate.

Preferably, this method according to the invention is carried out by applying the aqueous barrier layer composition C by surface application. More preferably, the coating is done using coating rollers (for example, Size Press, Metering Size Press) or using dispensing scraper systems (for example, creaming or blades) or non-contact dispensing systems (such as air-blades or curtains). The coating can also be applied in several successive steps using one or more of the coating methods. A pre-coat is then applied before one or more top coats, which may have different compositions. Also preferably, this method according to the invention is such that the barrier layer is resistant to at least one substance chosen among water, alcohols, natural oils, mineral oils, gas (water vapour, O₂, CO₂), fats, organic solvents, flavours, fragrances. Particularly preferably, this method makes it possible to control, slow or stop the migration through the cellulose substrate of at least one substance chosen among water, alcohols, natural oils, mineral oils, gas (water vapour, O₂, CO₂), fats, organic solvents, flavours, fragrances. Advantageously according to the invention, the barrier prepared using the composition C according to the invention makes it possible to act on the exchange kinetics between the inner and outer media of the cellulose substrate coated with this layer. In this way, the transfer kinetics of a particular substance are slowed down sufficiently, or even significantly, to form a barrier to that substance between the inner and outer media of the barrier layer.

Preferably for this method, the cellulose substrate is natural or plant-based or is a composite or mixed cellulose substrate. More preferably, the cellulose substrate is chosen among new paper, new cardboard, recycled paper, recycled cardboard and combinations thereof. Also preferably, the coated cellulose substrate is in the form of a container, of a package. More preferably, it is a food container, a food package, a non-food container, a non-food package, a drug container, a drug package, a container for oxidisable substances, a package for oxidisable substances, a container for hygroscopic substances, a package for hygroscopic substances.

In general, paper and cardboard are made primarily from virgin cellulose fibres produced from paper pulp, optionally blended with recovered fibres from recycled paper or recycled cardboard. The cellulose substrate can also comprise mineral pigments, process additives or functional additives to give it the desired optical properties, printability or mechanical properties.

The advantageous, particular or preferred characteristics of the aqueous suspension S according to the invention make it possible to define aqueous compositions C according to the invention which are also advantageous, particular or preferred. Likewise, the invention provides various advantageous, particular or preferred methods which are defined by the advantageous, particular or preferred characteristics of the aqueous suspension S according to the invention.

According to the invention, the molecular weight of the copolymers is determined by size exclusion chromatography (SEC). This technique uses a Waters liquid chromatography instrument equipped with two detectors. One combines light scattering at a 90° angle with viscometry measured by a Viscotek Malvern viscometer. The other is a Waters refractive index detector. This liquid chromatography instrument is equipped with size exclusion columns chosen in order to separate the various molecular weights of the polymers studied. The liquid elution phase is an aqueous phase containing 1% of KNO₃. In a first step, the polymerisation solution is diluted to 0.9% dry in the CES eluent, which is a 1% solution of KNO₃. Next, the solution is filtered through a 0.2 μm filter. 100 μL are then injected into the chromatography instrument (eluent: a 1% solution of KNO₃). The liquid chromatography instrument has an isocratic pump (Waters 515), the flow rate of which is set to 0.8 mL/min. The chromatography instrument also comprises an oven comprising the following system of columns in series: a Waters Ultrahydrogel Guard precolumn (6 cm in length and 40 mm in inner diameter), a Waters Ultrahydrogel straight column (30 cm in length and 7.8 mm in inner diameter) and two Ultrahydrogel 120 Å columns (30 cm in length and 7.8 mm in inner diameter). The detection system consists of a Waters 410 RI refractometric detector and a Malvern 270 Dual Detector viscometer and 900 light scattering detector. The oven is brought to a temperature of 55° C. and the refractometer is brought to a temperature of 45° C. The chromatography instrument is calibrated with a Malvern PolyCal single poly-ethoxylate standard (19,000 g/mol).

According to the invention, the pH is measured at 25° C. with a WTW pH-meter equipped with a conventional electrode coupled to a temperature probe.

According to the invention, the Brookfield viscosity of the compositions prepared is measured at 100 rpm and at 25° C. using an analogue viscosity meter. The rotor is chosen according to the viscosity of the composition studied so as to be within the optimal range of the rheometer.

According to the invention, particle sizes are measured using a Malvern Mastersizer 3000 laser particle size analyser. The method and instrument are known as such and are commonly used to determine the grain size of mineral fillers, pigments, or polymers. The measurement is carried out in an aqueous solution containing 0.10% by weight of Na₄P2O₇. The samples are dispersed using a high-speed agitator and optionally ultrasound.

The various aspects of the invention are illustrated by examples.

### Preparation of a Stabilising Agent c-A According to the Invention:

490 g of deionised water, 21.45 g of acrylic acid, 4.91 g of methacrylic acid and 217.40 g of a monomer c2 of formula I wherein R1 represents H, L1 represents a combination of 46 ethylene oxide (EO) groups and of 15 propylene oxide (PO) groups with a molecular weight of 3,000 g/mol are introduced into a tank reactor and heated to 64±1° C. Then, a mixture of 10 g of water, of 0.66 g of DMDO (2,2′-(ethylenedioxy)diethanethiol) and of 2.84 g of monomer c2 is injected in parallel into the reactor along with a mixture of 15 g of water and of 1.03 g of ammonium persulphate. The reactor is kept at a temperature of 65±2° C. for 1 hour and 30 minutes. Then, 0.61 g of ammonium persulphate dissolved in 20 g of deionised water is injected into the reactor. Lastly, it is cooked for 1 hour before allowing the medium to cool to room temperature. The stabilising agent c-A according to the invention is neutralised by adding an aqueous sodium hydroxide solution at 50% by weight (16.17 g). Its molecular weight measured by CES is 1,800,000 g/mol.

### Preparation of a Thickening Agent e-A According to the Invention:

An initial load consisting of 460 g of deionised water, of 4.29 g of sodium dodecyl sulphate and of 4.09 g of tridecyl alcohol tri-ethoxylate (Rhodasurf ID030, Solvay) is introduced into a glass reactor. 160.77 g of ethyl acrylate, 116.42 g of methacrylic acid, 5.66 g of a compound e3 of formula VII wherein q represents 36, r represents 0, EO independently represents an ethylene oxide group (CH₂CH₂O), R³ represents a methacrylate group and R⁴ represents a branched alkyl group comprising 20 carbon atoms, 1.50 g of sodium dodecyl sulphate and 112 g of deionised water are weighed in a first container, such as a glass beaker. 0.871 g of ammonium persulphate is weighed in a second container, such as a glass beaker, and dissolved in 10 g of deionised water. 0.087 g of sodium metabisulphite is weighed in a third container, such as a glass beaker, and dissolved in 10 g of deionised water. 9.31 g of 2-acrylamido-2-methylpropane sulphonic acid sodium salt at 50% by weight in water is weighed in a fourth container, such as a syringe. The contents of the reactor are heated to a temperature of 76° C.±2° C. In two hours, the reagents of the 4 containers are introduced into the polymerisation reactor at a temperature of 76° C.±2° C. Then, 0.098 g of ammonium persulphate dissolved in 12 g of deionised water are introduced. Then, the medium is cooked for 1 hour before being allowed to cool.

A thickening agent e-A according to the invention is obtained at 30.0% by weight of solids content.

### Preparation of an Aqueous Composition C1 According to the Invention:

An aqueous composition C1 according to the invention is prepared by mixing, in deionised water:
25 parts by dry weight of pigment: ground calcium carbonate (Omya H90 Me at 78% by weight of solids content),
75 parts by dry weight of binding agent: styrene-butadiene latex (Trinseo DL1066 at pH 7 and 55% by weight of solids content),
0.1 part by dry weight of stabilising agent c-A (in water at 25% by weight of solids content),
0.3 part by dry weight of thickening agent e-A (in water at 30% by weight of solids content).

The amount of water is adjusted to obtain a solids content of 49.8% by weight of composition C₁.

Similarly, a comparative aqueous composition CC1 is prepared by mixing, in deionised water:
25 parts by dry weight of pigment: ground calcium carbonate (Omya H90 Me at 78% by weight of solids content),
75 parts by dry weight of binding agent: styrene-butadiene latex (Trinseo DL1066 at pH 7 and 55% by weight of solids content),
0.3 part by dry weight of thickening agent e-A (in water at 30% by weight of solids content).

The amount of water is adjusted to obtain a solids content of 49.8% by weight of composition CC1.

### Evaluation of the Properties of Compositions C1 and CC1:

A sample of composition C1 and a sample of composition CC1 are prepared to measure their Brookfield viscosity at 25° C. and at 100 rpm. In addition, a 250 g sample of composition C1 is prepared and then filtered to separate the clusters with a size greater than 45 μm. The number of clusters separated by the filter is weighed. Similarly, the clusters with a size greater than 45 μm are separated from a 250 g sample of composition CC1. Measurements are taken twice for each sample. The results are shown in Table 1.

TABLE 1

| Composition | C1 | CC1 |
|---|---|---|
| Average amount (g) | 0.5 | 6.84 |
| Brookfield viscosity (mPa · s) | 1460 | 1660 |

By using a suspension according to the invention comprising the stabilising agent c-A, the composition C1 according to the invention has an extremely small number of clusters with a size greater than 45 μm. The comparative composition has nearly 14 times more clusters with a size greater than 45 μm.

Samples of composition C1 and of composition CC1 are prepared to measure the particle size distribution. These measurements are carried out in water using a laser particle size analyser (Malvern Mastersizer 3000 equipped with a hydro-LV tank) and processed with the Mastersizer 3000 software (refraction index 1.590, adsorption index 0.005, mixer speed 3,000 rpm).

Measurements are taken under red and blue lights. An aliquot measurement is taken. Three wash cycles are run between each series. For each composition and at similar obscuration levels, the particle size is measured and the results of the volume-average particle size measurements are shown in Table 2.

TABLE 2

| Composition | C1 | CC1 |
|---|---|---|
| Obscuration level - % | 6.86 | 6.52 |
| D(10) - μm | 0.12 | 3.05 |
| D(50) - μm | 4.48 | 8.97 |
| D(80) - μm | 11.20 | 27.70 |
| D(90) - μm | 18.50 | 47.20 |
| Maximum size - μm | 67 | 211 |

By using a suspension according to the invention comprising the stabilising agent c-A, the composition C1 according to the invention comprises a very small fraction (measured in volume) of clusters with a size greater than 18.50 μm. Additionally, the stabilising agent c-A according to the invention significantly reduces the maximum size of the clusters compared to the clusters of the comparative composition, which had a maximum size of 211 μm.

1: An aqueous mineral suspension for the preparation of an aqueous barrier layer composition for a cellulose substrate, comprising:
water and,
relative to a total amount of dry active ingredients in the aqueous mineral suspension,
a. 5 to 34.9% by dry weight of at least one mineral pigment (a) selected from the group consisting of alkaline-earth metal carbonates, magnesium carbonate, barium carbonate, dolomite, kaolin, titanium dioxide, talc, lime, calcium sulphate, barium sulphate, hexacalcium hexaoxotris-sulphato(2-)-dialuminate(12-) (white satin), silica and combinations thereof;
b. 65 to 93% by dry weight of at least one binding agent (b) selected from the group consisting of a binding agent (b1) in the form of a latex prepared by emulsion polymerisation and a polymer binding agent (b2) in the form of an aqueous dispersion and combinations thereof; and
c. 0.1 to 2% by dry weight of at least one stabilising agent (c) prepared by at least one polymerisation reaction:
of at least one monomer (c1) selected from the group consisting of acrylic acid, an acrylic acid salt, methacrylic acid, a methacrylic acid salt and combinations thereof; or
of at least one compound (c2) of formula (I): 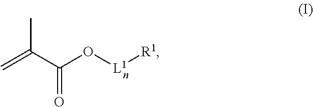
wherein:
R¹ independently represents an H or a CH₃ group;
L¹ independently represents ethylene oxide (EO) groups or a combination of EO groups and propylene oxide (PO) groups; and
n independently represents an integer or a decimal comprised between 20 and 200.

2: The aqueous mineral suspension according to claim 1, wherein:
the pigment (a) is selected from the group consisting of natural calcium carbonate, precipitated calcium carbonate, kaolin, calcined kaolin, talc, titanium dioxide and combinations thereof, or
the pigment (a) is in the form of particles, or
an equivalent spherical diameter of the particles of pigment (a), for a size, measured by laser diffraction, ranging from 0.05 μm to 10 and is equal to 60% by weight or more.

3: The aqueous mineral suspension according to claim 1, wherein:
the binding agent (b1) is a latex binder prepared by emulsion polymerisation of at least one ethylenically unsaturated monomer; or
the binding agent (b1) is a latex binder prepared by emulsion-polymerisation
of at least one monomer selected from the group consisting of styrene, ethylene, butadiene, vinyl acetate, carboxylic acids comprising an ethylenic unsaturation, acrylic acid ester, methacrylic acid ester, acrylamide, methacrylamide, acrylonitrile, methacrylonitrile, acrylonitrile ester, methacrylonitrile ester, combinations thereof and
of at least one additional monomer selected from the group consisting of fumaric acid, itaconic acid, maleic acid, fumaric acid ester, itaconic acid ester, maleic acid ester, silanes, siloxanes, and combinations thereof; or
the binding agent (b1) is a latex binder prepared by emulsion polymerisation and selected from the group consisting of acrylic latex, carboxylated styrene-butadiene latex, non-carboxylated styrene-butadiene latex, styrene-acrylate latex, styrene-butyl acrylate latex, butadiene-methyl methacrylate latex, butadiene-acrylonitrile latex, polyvinyl acetate latex and combinations thereof; or
the binding agent (b2) is selected from the group consisting of aqueous dispersions of bonding polymers selected from the group consisting of polyethylenes (PE), polypropylenes (PP), ethylene-vinyl acetate (EVA) polymers, ethylene-acrylic acid (EAA) polymers, ethylene-methacrylic acid (EMAA) polymers, ethylene-butyl acrylate (EBA) polymers, ethylene-methyl acrylate (EMA) polymers, styrene-isoprene block (SIS) copolymers, styrene-butadiene block (SBS) copolymers, styrene-ethylene-butylene block (SEBS) polymers, acrylic acid-modified ethylene copolymers, polyvinyl alcohols, modified polyvinyl alcohols, preferably EAA, EVA, SBS; or
the binding agent (b) is combined with at least one natural binding agent (b′).

4: The aqueous mineral suspension according to claim 1, wherein:
the agent (c) is a polymer prepared by a polymerisation reaction of at least one monomer (c1) selected from the group consisting of acrylic acid, methacrylic acid and combinations thereof, or
the agent (c) is a polymer prepared by a polymerisation reaction of at least one monomer (c2) of formula I wherein L¹ represents EO, or
the agent (c) is fully or partially neutralised, or
the agent (c) has a weight-average molecular weight M_{W} of less than 40,000,000 g/mol, or
the agent (c) has a weight-average molecular weight M_{W} measured by size exclusion chromatography (SEC) greater than 100,000 g/mol, or
the agent (c) has a weight-average molecular weight M_{W} measured by size exclusion chromatography (SEC) ranging from 1,000,000 g/mol to 5,000,000 g/mol, or
the agent (c) has a polymolecularity index (PI) measured by size exclusion chromatography (SEC) of less than 2.8, or
the agent (c) is a polymer prepared by a polymerisation reaction using at least one additional monomer, different from monomers (c1) and (c2), selected from the group consisting of:
a monomer (c3) selected from the group consisting of maleic acid, maleic anhydride, itaconic acid, 2-acrylamido-2-methylpropane sulphonic acid (AMPS), vinylsulphonic acid, 2-(methacryloyloxy)-ethanesulphonic acid, sodium methallyl sulphonate, styrene sulphonate and salts thereof, preferably itaconic acid, 2-acrylamido-2-methylpropane sulphonic acid (AMPS) and salts thereof; or
a compound (c4) of formula (II): 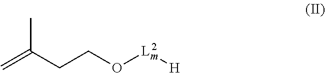
wherein in formula (II):
L² independently represents an EO group or a combination of EO and PO groups;
m independently represents an integer or a decimal comprised between 10 and 150;
EO independently represents an ethylene oxide group; and
PO independently represents a propylene oxide group; or
a monomer (c5) of formula (III): 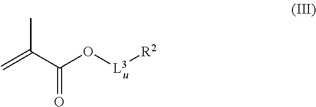
wherein in formula (III):
L³ independently represents an EO group or a combination of EO and PO groups;
u independently represents an integer or a decimal comprised between 10 and 150;
EO independently represents an ethylene oxide group;
PO independently represents a propylene oxide group; and
R² independently represents a H or a CH₃; or a monomer (c6) of formula (IV): 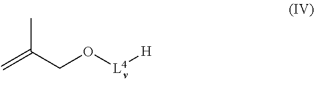
wherein in formula (IV):
L⁴ independently represents an EO group;
EO independently represents an ethylene oxide group; and
v independently represents an integer or a decimal comprised between 10 and 150; preferably between 20 and 75 or
a monomer (c6a) of formula (V): 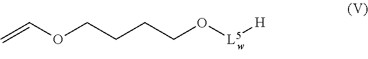
wherein in formula (V):
L⁵ independently represents an EO group;
EO independently represents an ethylene oxide group; and
w independently represents an integer or decimal
comprised between 10 and 150; or a compound (c7) of formula (VI): 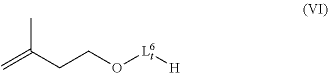
wherein in formula (VI):
L⁶ independently represents an EO group or a combination of EO and PO groups;
t independently represents an integer or a decimal comprised between 10 and 150;
EO independently represents an ethylene oxide group; and
PO independently represents a propylene oxide group.

5: The aqueous mineral suspension according to claim 1, wherein:
a concentration of clusters with a size greater than 20 μm, measured by laser diffraction, is less than 10% by volume, or
a concentration of clusters with a size greater than 10 μm, measured by laser diffraction, is less than 30% by volume.

6: The aqueous mineral suspension according to claim 1, further comprising, relative to the total amount of dry active ingredients of the aqueous mineral suspension,
a. 10 to 34.9% by dry weight of the mineral pigment (a);
b. 65 to 88% by dry weight of the binding agent (b); and
c. 0.1 to 2% by dry weight of agent (c).

7: An aqueous composition for preparing a barrier layer for a cellulose substrate, comprising:
relative to the total amount of composition,
from 95 to 99.95% by weight of at least one of the aqueous mineral suspension according to claim 1, and
from 0.05 to 5% by weight of at least one thickening agent (e) selected from the group consisting of ASE polymers, HASE polymers and combinations thereof.

8: The aqueous composition according to claim 7, wherein:
the thickening agent (e) is an ASE polymer prepared by at least one polymerisation reaction,
of at least one monomer (e1) selected from the group consisting of acrylic acid, an acrylic acid salt, methacrylic acid, a methacrylic acid salt and combinations thereof; and
of at least one monomer (e2) selected from the group consisting of C₁-C₈ esters of a compound derived from an acid selected from the group consisting of acrylic acid, methacrylic acid and combinations thereof; or
the thickening agent (e) is an HASE polymer prepared by at least one polymerisation reaction
of at least one monomer (e1),
of at least one monomer (e2) and
of at least one hydrophobic monomer (e3) of formula VII: 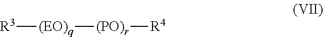
wherein in formula VII:
q and r, identical or different, independently represent 0 or an integer or a decimal less than 150, q or r being different from 0,
EO independently represents an ethylene oxide group (CH₂CH₂O),
PO independently represents a propylene oxide group (CH(CH₃)CH₂O or CH₂CH(CH₃)O),
R³ represents a group comprising at least one polymerisable olefinic unsaturation, and
R⁴ represents a straight or a branched C₆-C₄₀-alkyl group, a phenyl group, a polyphenyl group; or a group comprising 2 to 5 phenyl groups or a tristyrylphenyl group or a pentastyrylcumylphenyl group.

9: The aqueous composition according to claim 7, wherein:
an ASE polymer is prepared by at least one polymerisation reaction comprising:
from 20 to 75 mol % of monomer (e1), and
from 25 to 80 mol % of monomer (e2),
relative to a total molar amount of monomers (e1) and (e2); or
an HASE polymer is prepared by at least one polymerisation reaction comprising:
from 20 to 75 mol % of monomer (e1), and
from 25 to 80 mol % of monomer (e2), and
less than 20 mol % of monomer (e3),
relative to a total molar amount of monomers (e1), (e2), and (e3).

10: The aqueous composition according to claim 7, wherein the ASE polymer or the HASE polymer is prepared by at least one polymerisation reaction that also uses at least one different additional monomer selected from the group consisting of:
a compound monomer (e4) that is less than 20 mol % relative to a total molar amount of monomers, selected from the group consisting of 2-acrylamido-2-methylpropane sulphonic acid, ethoxymethacrylate sulphonic acid, sodium methallyl sulphonate, styrene sulphonate, hydroxyethyl acrylate phosphate, hydroxypropyl acrylate phosphate, hydroxyethyl methacrylate phosphate, hydroxypropyl methacrylate phosphate, their salts and combinations thereof, or
a compound monomer (e5) less than 20 mol % relative to the total molar amount of monomers, selected from the group consisting of hydroxyethyl-acrylate, hydroxypropyl-acrylate, hydroxyethylhexyl-acrylate, hydroxyethyl methacrylate, hydroxypropyl methacrylate; or
a cross-linking monomer (e6) or at least one monomer (e6) comprising at least two olefinic unsaturations and is less than 5 mol % relative to the total molar amount of monomers.

11: The aqueous composition according to claim 7, wherein:
the thickening agent (e) is fully or partially neutralised, or
the thickening agent (e) is fully or partially coacervated,
by reducing a pH to a value of less than 6.5 with an acid compound, or
by increasing an ionic strength by adding at least one ionised compound or at least one salt.

12: The aqueous composition according to claim 7, wherein a concentration of clusters with a size greater than 20 μm, measured by laser diffraction, is less than 10% by volume.

13: The aqueous composition according to claim 7, wherein:
a Brookfield viscosity, measured at 25° C. at a speed of 100 rpm, is greater than 100 mPa·s, or
a Brookfield viscosity, measured at 25° C. at a speed of 100 rpm, ranges from 100 to 3,000 mPa·s, and
the aqueous composition has a pH greater than 5, and a pH less than 11.

14: A method of preparing an aqueous barrier layer composition for a cellulose substrate, comprising:
a. preparing the aqueous mineral suspension according to claim 1 by mixing, in water, relative to the total amount of dry active ingredients of the suspension,
5 to 34.9% by dry weight of at least one mineral pigment (a),
65 to 93% by dry weight of at least one binding agent (b), and
0.1 to 2% by dry weight of at least one stabilising agent (c); and
b. adding from 0.05 to 5% by dry weight of a composition C of at least one thickening agent (e) selected from the group consisting of ASE polymers, HASE polymers and combinations thereof.

15: A method of preparing a barrier layer for a cellulose substrate comprising:
applying the aqueous composition according to claim 7 to at least one surface of a cellulose substrate.

16: The method according to claim 15, wherein:
the cellulose substrate is a natural cellulose substrate, a plant-based cellulose substrate, a composite cellulose substrate, or a mixed cellulose substrate; or
a coated cellulose substrate in the form of a container or a package.

17: The method according to claim 15, further comprising:
coating the aqueous barrier layer composition
wherein the aqueous barrier layer is resistant to at least one substance selected from the group consisting of water, alcohols, natural oils, mineral oils, gas, fats, organic solvents, flavours, and fragrances.

18: The aqueous mineral suspension according to claim 1, wherein:
the pigment (a) is selected from the group consisting of natural calcium carbonate, precipitated calcium carbonate, kaolin, calcined kaolin, talc, titanium dioxide and combinations thereof, or
the pigment (a) is in the form of particles with a size, measured by laser diffraction, of less than 5 μm, or
an equivalent spherical diameter of the particles of pigment (a), for a size, measured by laser diffraction, a size of less than 8 μm, and is equal to equal to 70% by weight or more.

19: The aqueous mineral suspension according to claim 1, wherein:
the binding agent (b1) is a latex binder prepared by emulsion polymerisation of at least one ethylenically unsaturated monomer selected from the group consisting of styrene, ethylene, butadiene, vinyl acetate, carboxylic acids comprising an ethylenic unsaturation, acrylic acid ester, methacrylic acid ester, acrylamide, methacrylamide, acrylonitrile, methacrylonitrile, acrylonitrile ester, methacrylonitrile ester and combinations thereof; or
the binding agent (b1) is a latex binder prepared by emulsion-polymerisation
of at least one monomer selected from the group consisting of styrene, ethylene, butadiene, vinyl acetate, carboxylic acids comprising an ethylenic unsaturation, acrylic acid, methacrylic acid, acrylic acid ester, methacrylic acid ester, acrylamide, methacrylamide, acrylonitrile, methacrylonitrile, acrylonitrile ester, methacrylonitrile ester, combinations thereof and
of at least one additional monomer selected from the group consisting of fumaric acid, itaconic acid, maleic acid, fumaric acid ester, itaconic acid ester, maleic acid ester, silanes, siloxanes, and combinations thereof; or
the binding agent (b1) is a latex binder prepared by emulsion polymerisation and selected from the group consisting of acrylic latex, carboxylated styrene-butadiene latex, non-carboxylated styrene-butadiene latex, styrene-acrylate latex, styrene-butyl acrylate latex, butadiene-methyl methacrylate latex, butadiene-acrylonitrile latex, polyvinyl acetate latex and combinations thereof; or
the binding agent (b2) is selected from the group consisting of aqueous dispersions of bonding polymers selected from the group consisting of polyethylenes (PE), polypropylenes (PP), ethylene-vinyl acetate (EVA) polymers, ethylene-acrylic acid (EAA) polymers, ethylene-methacrylic acid (EMAA) polymers, ethylene-butyl acrylate (EBA) polymers, ethylene-methyl acrylate (EMA) polymers, styrene-isoprene block (SIS) copolymers, styrene-butadiene block (SBS) copolymers, styrene-ethylene-butylene block (SEBS) polymers, acrylic acid-modified ethylene copolymers, polyvinyl alcohols, modified polyvinyl alcohols, EAA, EVA, SBS; or
the binding agent (b) is combined with at least one natural binding agent (b′) selected from the group consisting of carboxymethyl celluloses, starches, modified starches, proteins, caseins, alginates, and combinations thereof.

20: The aqueous mineral suspension according to claim 1, wherein:
a concentration of clusters with a size greater than 20 μm, measured by laser diffraction, is less than 10% by volume, or
a concentration of clusters with a size greater than 10 μm, measured by laser diffraction, is less than 30% by volume.
